(19) United States
(12) Patent Application Publication
(10) Pub. No.: US 2021/0123582 A1
(43) Pub. Date: Apr. 29, 2021

(54) STAGE LAMP LIGHTING DEVICE

(71) Applicant: YLX INCORPORATED, Shenzhen (CN)

(72) Inventors: Quan ZHANG, Shenzhen (CN); Siyuan ZOU, Shenzhen (CN); Yufei ZHANG, Shenzhen (CN); Yi LI, Shenzhen (CN)

(21) Appl. No.: 16/605,741

(22) PCT Filed: Jul. 28, 2017
(86) PCT No.: PCT/CN2017/094800

§ 371 Date: Oct. 16, 2019

(30) Foreign Application Priority Data
Apr. 17, 2017 (CN) 201720402583.X

(51) Int. Cl. F21V 9/08; F21V 9/40; F21V 3/00; F21V 23/00; F21V 5/00

(52) U.S. Cl. CPC F21V 9/08; F21V 9/40; F21W 2131/406; F21V 23/003; F21V 5/002; F21V 3/00

(57) ABSTRACT

Disclosed is a stage lamp lighting device. The stage lamp lighting device, includes: a light emitting device configured to emit monochromatic lights of at least two colors; a light combining device configured to combine the monochromatic lights of the at least two colors into one beam of light; and a light mixing device configured to mix the monochromatic lights of different colors in the beam of light emitted from the light combining device and convert the beam of light into a Gaussian beam. The light combining device and light mixing device are sequentially arranged in a light emission path of the light-emitting device. As the Gaussian beam has high luminance at a center thereof, thus the user requirement for the center luminance at a specific distance is satisfied.

### TECHNICAL FIELD

The present disclosure relates to the field of lighting technologies, and more particularly, to a lighting device for a stage lamp.

### BACKGROUND

A stage lamp can provide necessary lamplight effect due to its linear light beam of multi-primary colors, so that it always plays an extremely important role in performance places, such as a stage or a theater.

However, mixing of light having different colors in a lighting device for a stage lamp is achieved usually by a double fly-eye lens. Under influence of optical properties of the double fly-eye lens itself, the light spot of the light beam finally emitted from the lighting device is very uniform. Nevertheless, while uniformity of the light spot will inevitably lead to a decrease in center luminance of the light spot, thereby causing the light spot finally emitted from the lighting device unable to meet user requirements on the center luminance of the light spot at a specific distance.

### SUMMARY

The present disclosure provides a following technical solution:

A lighting device for a stage lamp, including:

a light-emitting device configured to emit monochromatic lights of at least two colors;

a light combining device configured to combine the monochromatic lights of the at least two colors into one beam of light; and

a light mixing device configured to mix the monochromatic lights of different colors in the beam of light emitted from the light combining device, and convert the beam of light into a Gaussian beam,

the light combining device and the light mixing device are sequentially provided in a light emission path of the light-emitting device.

In one embodiment, the light mixing device includes a diffusion sheet which includes a light emission surface and a light incidence surface; wherein the light incidence surface is adapted to face the light combining device; and

wherein the light emission surface includes a plurality of microstructures; or

the light incidence surface and/or the light emission surface includes a plurality of microstructures.

In one embodiment, the plurality of microstructures is a plurality of protrusions formed by processing the diffusion sheet through a laser etching process or a chemical etching process; and

a light pattern of the Gaussian beam depends on a shape and a size of each of the plurality of protrusions.

In one embodiment, a distance between the diffusion sheet and the light combining device ranges from 1 mm to 10 mm.

In one embodiment, the light emission surface and/or the light incidence surface is provided with an anti-reflection film.

In one embodiment, a length of the light emission surface or a length of the light incidence surface ranges from 15 mm to 25 mm;

a width of the light emission surface or a width of the light incidence surface ranges from 15 mm to 25 mm; and each of the plurality of microstructures has a size ranging from 1 μm to 2 mm.

In one embodiment, further including:

a condensing lens, an aperture and a field lens that are sequentially provided in a light emission path of the light mixing device,

wherein the Gaussian beam emitted by the light mixing device is emitted after passing through the condensing lens, the aperture and the field lens.

In one embodiment, the light-emitting device includes:

a first light-emitting component configured to emit monochromatic light of a first color;

a second light-emitting component configured to emit monochromatic light of a second color;

a third light-emitting component configured to emit monochromatic light of a third color; and

a controller connected to the first light-emitting component, the second light-emitting component and the third light-emitting component, and configured to control turning on, turning off and luminous intensity of the first light-emitting component, the second light-emitting component and the third light-emitting component, respectively.

In one embodiment, the light combining device includes two light combining sheets that are perpendicular to each other in a cross manner;

one of the two light combining sheets is configured to transmit the monochromatic light of the first color and the monochromatic light of the second color and to reflect the monochromatic light of the third color; and

the other one of the two light combining sheets is configured to transmit the monochromatic light of the first color and the monochromatic light of the third color and to reflect the monochromatic light of the second color.

In one embodiment, further including: a light collecting lens array and a lens array,

wherein the light collecting lens array includes a plurality of light collecting lenses, and the lens array includes a plurality of lenses, wherein the plurality of light collecting lens and the plurality of lens are sequentially provided in a light emission path of the light-emitting component.

### Beneficial Effect

Compared with the related art, the technical solution provided by the present disclosure has following advantages:

In the lighting device for a stage lamp provided by the present disclosure, after the light-emitting device emits monochromatic lights of at least two colors, the light combining device combines the monochromatic lights of the at least two colors into one beam of light, and the light mixing device mixes the monochromatic lights of different colors in the beam of light emitted from the light combining device, and converts the beam of light into a Gaussian beam. Since a light spot formed by the Gaussian beam is not a uniform light spot but a light spot with a center being brighter and an edge being darker, that is, center luminance of the light spot is relatively high, and thus user's requirements for the center luminance of the light spot at a specific distance can be satisfied.

### BRIEF DESCRIPTION OF DRAWINGS

In order to better illustrate embodiments of the present disclosure or the technical solutions in the related art, the drawings used in the embodiments or the related art description will be briefly introduced below. It is apparent that the drawings described below are only a part of the embodiments of the present disclosure, and for those skilled in the art, other drawings can be obtained according to the provided drawings without any creative efforts.

FIG. 1 is a structural schematic diagram of a lighting device for a stage lamp in the related art;

FIG. 2 is a structural schematic diagram of a lighting device for a stage lamp according to an embodiment of the present disclosure;

FIG. 3 is a structural schematic diagram of another lighting device for a stage lamp according to an embodiment of the present disclosure;

FIG. 4 is a schematic diagram of a light beam emitted by the lighting device for a stage lamp shown in FIG. 1; and

FIG. 5 is a schematic diagram of a light beam emitted by a lighting device for a stage lamp according to an embodiment of the present disclosure.

### DESCRIPTION OF EMBODIMENTS

The technical solutions in the embodiments of the present disclosure are clearly and completely described in the following with reference to the accompanying drawings in the embodiments of the present disclosure. It is apparent that the described embodiments are only a part of the embodiments of the present disclosure but not all of the embodiments. All other embodiments obtained by those skilled in the art based on the embodiments of the present disclosure without creative efforts are within the scope of the present disclosure.

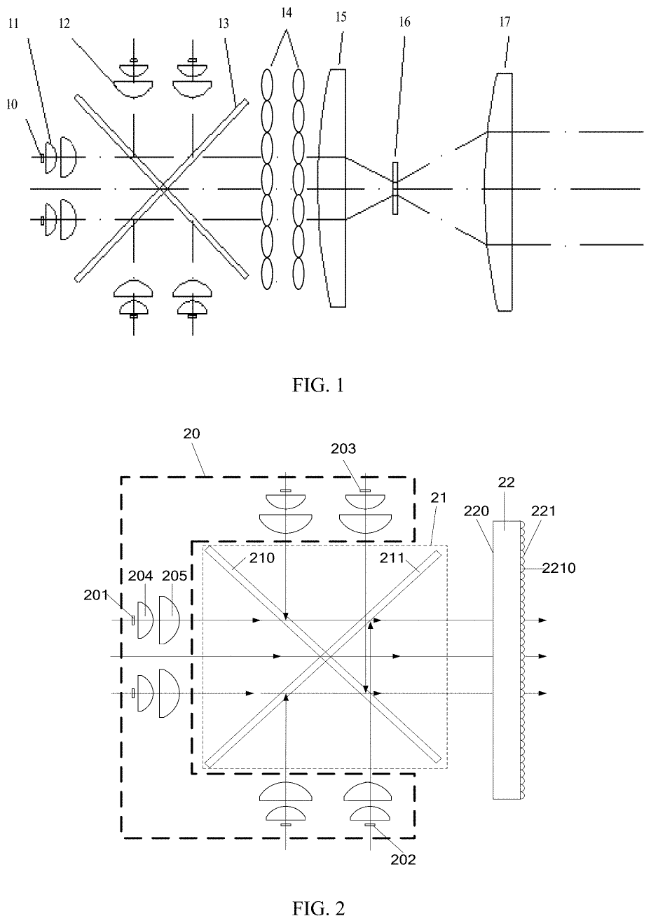

As shown in FIG. 1, a lighting device for a stage lamp disclosed in the related art includes: LEDs (Light-Emitting Diodes) 10 respectively emitting red light, green light and blue light, a light collecting lens 11, a lens array 12, a light combining sheet 13, a double fly-eye lens 14, a condensing lens 15, an aperture 16 and a field lens 17. The light emitted by the LEDs 10 enters into the light combining sheet 13 to be combined after being collimated by the light collecting lens 11 and the lens array 12, and then is mixed by the double fly-eye lens 14 and condensed by the condensing lens 15 so as to form a uniform light spot at the aperture 16 and finally emitted through the field lens 17 as a semi-collimated light beam.

However, since mixing of light having different colors in the lighting device is achieved by the double fly-eye lens 14, under influence of optical properties of the double fly-eye lens 14 itself, the light spot of the light beam finally emitted from the lighting device is very uniform. Nevertheless, uniformity of the light spot will inevitably lead to a decrease in center luminance of the light spot, thereby causing the light spot finally emitted from the lighting device unable to meet user requirements on the center luminance of the light spot at a specific distance.

An embodiment of the present disclosure provides a lighting device for a stage lamp as shown in FIG. 2, which includes a light-emitting device 20, and a light combining device 21 and a light mixing device 22 which are sequentially provided in a light emission path of the light-emitting device 20.

The light-emitting device 20 is configured to emit monochromatic lights of at least two colors; the light combining device 21 is configured to combine the monochromatic lights of at least two colors into one beam of light; and the light mixing device 22 is configured to mix the monochromatic lights of different colors in the light beam emitted from the light combining device 21 and convert the light beam into a Gaussian beam, such that the Gaussian beam is emitted as stage illuminating light.

In the present embodiment, the light-emitting device 20 includes at least two types of light-emitting components, such as a light-emitting component for emitting yellow light and a light-emitting component for emitting blue light. It is appreciated that, the present disclosure is not limited thereto. In one embodiment, the light-emitting device 20 may include three types of light-emitting components. As shown in FIG. 2, it includes a first light-emitting component 201, a second light-emitting component 202, and a third light-emitting component 203. The first light-emitting component 201 is configured to emit monochromatic light of a first color, the second light-emitting component 202 is for emitting monochromatic light of a second color, and the third light-emitting component 203 is for emitting monochromatic light of a third color.

Optionally, the monochromatic light of the first color is red light, the monochromatic light of the second color is green light, and the monochromatic light of the third color is blue light. It is appreciated that, the present disclosure is not limited thereto, as long as the monochromatic lights emitted by the first light-emitting component 201, the second light-emitting component 202, and the third light-emitting component 203 can be combined into white light. In addition, the first light-emitting component 201, the second light-emitting component 202, and the third light-emitting component 203 in the present embodiment are all LEDs. However, the present disclosure is not limited thereto. In other embodiments, the first light-emitting component 201, the second light-emitting component 202, and the third light-emitting component 203 may also be lasers or the like.

In addition, the light-emitting device 20 in the present embodiment further includes a controller (not shown in the figures) connected to the first light-emitting component 201, the second light-emitting component 202 and the third light-emitting component 203. The controller is configured to control turning on, turning off and luminous intensity of the first light-emitting component 201, the second light-emitting component 202 and the third light-emitting component 203, respectively. For example, when it is required to output the stage illuminating light, the controller will control to turn on the first light-emitting component 201, the second light-emitting component 202 and the third light-emitting component 203 simultaneously or in a time-division manner; when it is not required to output the stage illuminating light, the controller will control to turn off the first light-emitting component 201, the second light-emitting component 202 and the third light-emitting component 203 simultaneously or in the time-division manner; when it is required to adjust the intensity of the stage illuminating light, the controller adjusts the luminous intensity of the first light-emitting component 201, the second light-emitting component 202 and/or the third light-emitting component 203.

Further, the lighting device 20 in the present embodiment further includes a light collecting lens array and a lens array. The light collecting lens array includes a plurality of light collecting lenses 204, and the lens array includes a plurality of lenses 205. One light collecting lens 204 and one lens 205 are sequentially provided in the light emission path of each of the light-emitting components 201/202/203, for collimating the light emitted by the light-emitting component 201/202/203.

In the present embodiment, the light combining device 21 includes two light combining sheets 210 and 211 which are disposed perpendicularly to each other in a cross. As shown in FIG. 2, the light combining sheet 210 transmits the monochromatic light of the first color and the monochromatic light of the second color and reflects the monochromatic light of the third color; the other light combining sheet 211 transmits the monochromatic light of the first color and the monochromatic light of the third color and reflects the monochromatic light of the second color. For example, when the monochromatic light of the first color is red light, the monochromatic light of the second color is green light and the monochromatic light of the third color is blue light, the light combining sheet 210 is a film that transmits the red light and the green light and reflects the blue light, and the light combining sheet 211 is a film that transmits the red light and the blue light and reflects the green light.

Moreover, the light collecting sheets 210 and 211 are provided perpendicularly to each other in a cross to form three light inputs and one light output. The first light-emitting component 201, the second light-emitting component 202 and the third light-emitting component 203 are respectively provided at the three light inputs. It should be noted that the first light-emitting component 201, the second light-emitting component 202 and the third light-emitting component 203 are required to be provided at such positions that the monochromatic light of the first color, the monochromatic light of the second color and the monochromatic light of the third color can all be emitted from the light output of the light combining sheets 210 and 211, in order to combine monochromatic lights of three colors emitted by the light-emitting device 20 into one beam of light, for example, to initially mix the red, green and blue lights into one beam of light.

Optionally, the light combining sheets 210 and 211 in the present embodiment are both dichroic sheets. It is appreciated that, the present disclosure is not limited thereto. In other embodiments, the light combining sheets 210 and 211 may also be a light transmitting sheet coated with a light-splitting and light-transmitting film or the like. In another embodiment of the present disclosure, the light combining sheets 210 and 211 may also be arranged in parallel to achieve combining of lights of different colors, which will not be described herein.

In the present embodiment, the light mixing device 22 includes a diffusion sheet, which is specifically a diffusion sheet with microstructures. As shown in FIG. 2, the diffusion sheet includes a light incidence surface 220 and a light emission surface 221. The light incidence surface 220 is adapted to face the light combining device 21, and the light emission surface 221 has a plurality of microstructures 2210. Optionally, the plurality of microstructures 2210 are arranged in an array. Based on this, after a light beam emitted from the light combining device 21 enters into the diffusion sheet with microstructures, it is converted, under a scattering effect of the microstructures 2210, into a Gaussian beam and emitted. Since a light spot formed by the Gaussian beam is not a uniform light spot but a light spot with a center being brighter and an edge being darker, that is, center luminance of the light spot is relatively high, and thus the user's requirements for the center luminance of the light spot at a specific distance can be satisfied. When a light intensity at the edge of the light beam emitted from the diffusion sheet is reduced to 60% of a light intensity at the center, a divergence half angle thereof is 1° to 10°. In addition, under the scattering effect of the microstructures 2210, the monochromatic lights of different colors will be further mixed more uniformly, so that the stage illuminating light finally emitted meets the user's visual requirements.

In the present embodiment, the microstructures 2210 are separate protrusions formed by processing the light emission surface 221 of the diffusion sheet through processes such as laser etching or chemical etching. A shape and a size of the protrusion can be adjusted according to actual conditions. That is, a surface curvature of a specific protrusion can be obtained based on requirements of a light pattern of the emitted Gaussian beam so as to adjust the shape and the size of the protrusion. That is, the shape of the microstructure 2210 in the present embodiment is not limited to a semicircle, and it may be a quadrangle or a hexagon or the like.

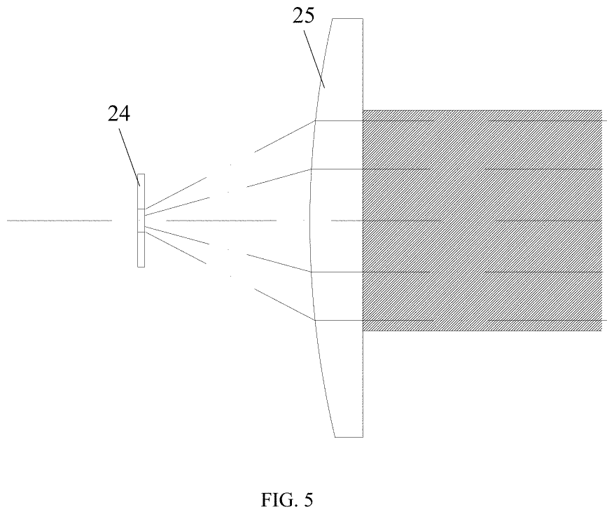

Optionally, the microstructure in the present embodiment has a size ranging from 1 μm to 2 mm. Since the size of the microstructure 2210 is much smaller than a size of a fly-eye unit of a fly-eye lens, the light beam finally emitted by the lighting device in the present embodiment is no longer individual bundles discrete from each other as shown in FIG. 4 but a bundle of light which is truly integrated and visually perfect as shown in FIG. 5, which further eliminates dark areas among the mutually discrete light bundles, thereby well solving problems of discrete light bundles and dark areas in the existing light-emitting device

In the present embodiment, the diffusion sheet shown in FIG. 2 has microstructures only on the light emission surface 221, but the present disclosure is not limited thereto. In other embodiments, the light incidence surface 220 and/or the light emission surface 221 of the diffusion sheet may each have a plurality of microstructures. In the present embodiment, in order to increase the transmittance of the diffusion sheet, an anti-reflection film may be provided on the light incidence surface 220 and/or the light emission surface 221 of the diffusion sheet. In the present embodiment, on the basis that the light emission surface 221 has the microstructures 2210, the anti-reflection film may be provided on the light incidence surface 220 to increase the transmittance of the diffusion sheet. Optionally, the anti-reflection film may be an AR anti-reflection film, and after the AR anti-reflection film is provided, the transmittance of the diffusion sheet may be increased to 97% or more.

Further, in the present embodiment, a distance between the diffusion sheet and the light combining device 21 may range from 1 mm to 10 mm, and further preferably from 1 mm to 3 mm, which can reduce the space and make the structure of the lighting device more compact. In addition, an overall outline dimension of the diffusion sheet in the present embodiment may be set to be substantially the same as an overall outline dimension of the existing fly-eye lens, so that there is no need to change dimensions of other structural members of the lighting device, thus there is no need to rebreak the mould, thereby avoiding an increase in cost. Optionally, a length of the light emission surface 221 or the light incidence surface 220 of the diffusion sheet ranges from 15 mm to 25 mm; a width of the light emission surface 221 or the light incidence surface 220 ranges from 15 mm to 25 mm.

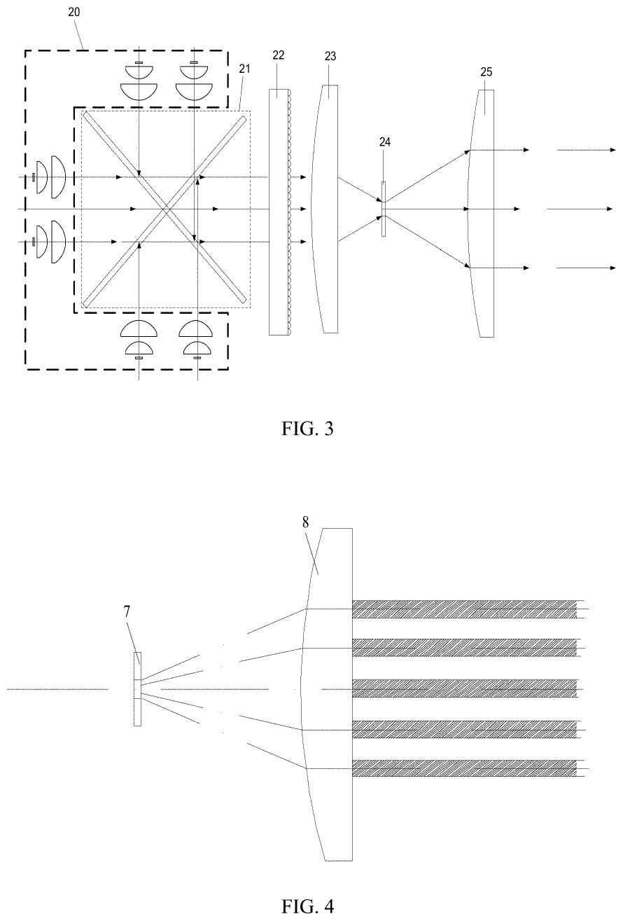

In an embodiment of the present disclosure, as shown in FIG. 3, the lighting device further includes a condensing lens 23, an aperture 24 and a field lens 25 which are sequentially provided in the light emission path of the light mixing device 22. The Gaussian beam emitted from the light mixing device 22 passes through the condensing lens 23, the aperture 24 and the field lens 25, and is finally emitted as stage illuminating light.

A process for emitting the illuminating light will be described below in conjunction with the lighting device structure shown in FIG. 3. The case, in which the first light-emitting component 201 emits red light, the second light-emitting component 202 emits green light and the third light-emitting component 203 emits blue light, is taken as an example for description. The red light emitted from the first light-emitting component 201, the green light emitted from the second light-emitting component 202 and the blue light emitted from the third light-emitting component 203 enter into the light combining device 21, i.e., the light combining sheet, and are combined after being collimated by the light collecting lens 204 and the lens 205, then mixed and converted into the Gaussian beam by the light mixing device 22, i.e., the diffusion sheet, and then condensed by the condensing lens 23, to form, at the aperture 24, an nonuniform light spot which has a uniform color mixture and has the center brightness higher than the edge brightness. As shown in FIG. 5, the light spot is finally emitted through the field lens 25 as a semi-collimated light beam, and the semi-collimated light beam can be emitted as the final stage illuminating light.

With the lighting device for a stage lamp provided by the present disclosure, after the light-emitting device emits monochromatic lights of at least two colors, the light combining device combines the monochromatic lights of the at least two colors into one beam of light, and the light mixing device mixes the monochromatic lights of different colors in the light beam emitted from the light combining device, and converts the light beam into a Gaussian beam. Since a light spot formed by the Gaussian beam is not a uniform light spot but a light spot with a center being brighter and an edge being darker, that is, center luminance of the light spot is relatively high, and thus the user's requirements for the center luminance of the light spot at a specific distance can be satisfied.

The various embodiments in the present specification are described in a progressive manner, and each embodiment focuses on differences from other embodiments, and the same and similar parts between the various embodiments may be referred to each other.

The above description of the disclosed embodiments enables those skilled in the art to achieve or use the present disclosure. Various modifications to these embodiments are obvious to those skilled in the art, and the general principles defined herein may be implemented in other embodiments without departing from the spirit or scope of the present disclosure. Therefore, the present disclosure is not intended to be limited to the embodiments illustrated herein, but conforms to the broadest scope consistent with the principles and novel features disclosed herein.

1. A lighting device for a stage lamp, comprising:
a light-emitting device configured to emit monochromatic lights of at least two colors;
a light combining device configured to combine the monochromatic lights of the at least two colors into one beam of light; and
a light mixing device configured to mix the monochromatic lights of different colors in the beam of light emitted from the light combining device, and convert the beam of light into a Gaussian beam,
wherein the light combining device and the light mixing device are sequentially provided in a light emission path of the light-emitting device.

2. The lighting device according to claim 1, wherein the light mixing device comprises a diffusion sheet with a plurality of microstructures.

3. The lighting device according to claim 2, wherein each of the plurality of microstructures is a protrusion formed on a surface of the diffusion sheet.

4. The lighting device according to claim 2, wherein a distance between the diffusion sheet and the light combining device ranges from 1 mm to 10 mm.

5. The lighting device according to claim 2, wherein the light emission surface and/or the light incidence surface is provided with an anti-reflection film.

6. The lighting device according to claim 2, wherein a length of the light emission surface or a length of the light incidence surface ranges from 15 mm to 25 mm; and
a width of the light emission surface or a width of the light incidence surface ranges from 15 mm to 25 mm.

7. The lighting device according to claim 1, further comprising:
a condensing lens, an aperture and a field lens that are sequentially provided in a light emission path of the light mixing device,
wherein the Gaussian beam emitted by the light mixing device is emitted after passing through the condensing lens, the aperture and the field lens.

8. The lighting device according to claim 1, wherein the light-emitting device comprises:
a first light-emitting component configured to emit monochromatic light of a first color;
a second light-emitting component configured to emit monochromatic light of a second color;
a third light-emitting component configured to emit monochromatic light of a third color; and
a controller connected to the first light-emitting component, the second light-emitting component and the third light-emitting component, and configured to control turning on, turning off and luminous intensity of the first light-emitting component, the second light-emitting component and the third light-emitting component, respectively.

9. The lighting device according to claim 8, wherein the light combining device comprises two light combining sheets that are perpendicular to each other in a cross manner;
one of the two light combining sheets is configured to transmit the monochromatic light of the first color and the monochromatic light of the second color and to reflect the monochromatic light of the third color; and
the other one of the two light combining sheets is configured to transmit the monochromatic light of the first color and the monochromatic light of the third color and to reflect the monochromatic light of the second color.

10. The lighting device according to claim 8, further comprising: a light collecting lens array and a lens array,
wherein the light collecting lens array comprises a plurality of light collecting lenses, and the lens array comprises a plurality of lenses, wherein the plurality of light collecting lens and the plurality of lens are sequentially provided in a light emission path of the light-emitting component.

11. The lighting device according to claim 2, wherein the diffusion sheet comprises a light emission surface facing the light combining device and a light incidence surface; and
wherein the plurality of microstructures are formed on the light incidence surface or the light emission surface.

12. The lighting device according to claim 2, wherein the diffusion sheet comprises a light emission surface facing the light combining device and a light incidence surface; and
wherein the plurality of microstructures are formed on the light incidence surface and the light emission surface.

13. The lighting device according to claim 3, wherein a shape and a size of the protrusions are determined based on light pattern of the Gaussian beam.

14. The lighting device according to claim 2, wherein the plurality of protrusions are formed by processing the diffusing sheet through a laser etching process or a chemical etching process.

15. The lighting device according to claim 2, wherein each of the plurality of microstructures has a size ranging from 1 μm to 2 mm.

16. The lighting device according to claim 2, wherein a size of each of the plurality of microstructures is smaller than that of a fly-eye unit of a fly-eye lens.

17. The lighting device according to claim 2, wherein the plurality of microstructures are arranged in an array.

18. The lighting device according to claim 2, wherein the plurality of microstructures are configured in such a manner that light intensity at an edge of the beam of light emitted from the diffusion sheet is reduced to 60% of that at a center of the beam of light with a divergence half angle ranging from 1° to 10°.

19. The lighting device according to claim 2, wherein the plurality of microstructures are configured in such a manner that a light spot formed by the Gaussian beam is a light spot with a center being brighter and an edge being darker.

20. A lighting device for a stage lamp, comprising:
a light-emitting device configured to emit monochromatic lights of at least two colors;
a light combining device configured to combine the monochromatic lights of the at least two colors into one beam of light; and
a light mixing device configured to mix the monochromatic lights of different colors in the beam of light emitted from the light combining device, and convert the beam of light into a Gaussian beam,
wherein the light combining device and the light mixing device are sequentially provided in a light emission path of the light-emitting device; and
wherein the light mixing device comprises a diffusion sheet with a plurality of microstructures formed on a surface of the diffusion sheet and configured to convert the beam of light emitted from the light combining device into the Gaussian beam a light spot of which has a center brighter and an edge darker.
